(19) United States
(12) Patent Application Publication
(10) Pub. No.: US 2006/0089752 A1
(43) Pub. Date: Apr. 27, 2006

(54) Method of and system for reducing utility costs associated with machine operation

(76) Inventor: Donald R. Voigt, Port Washington, WI (US)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(21) Appl. No.: 11/256,821

(22) Filed: Oct. 24, 2005

Related U.S. Application Data
(60) Provisional application No. 60/622,649, filed on Oct. 27, 2004.

(51) Int. Cl. G05D 7/00

(52) U.S. Cl. 700/282

(57) ABSTRACT

A method and control system are provide for controlling operation of a pump station having a wetwell for receiving water therein. The control system includes a controller operatively connected to lead and lag pumps. The controller monitors the water level of the water in the wetwell and inhibits operation of the lead pump during a predetermined peak consumption period if the water level falls between a first threshold level and a second threshold level. Alternatively, the controller activates the lead pump during the predetermined peak consumption period if the water level exceeds the second threshold level or if the water level exceeds the first threshold level and the time period is outside the predetermined peak consumption period.

### CROSS-REFERENCE TO RELATED APPLICATION

This application claims the benefit of U.S. Provisional Application Ser. No. 60/622,649, filed Oct. 27, 2004.

### FIELD OF THE INVENTION

This invention relates generally to control systems for machines, and in particular, to a method and control system configured to control operation of a machine or combination of machines in a manner that minimizes the operating costs associated with the electrical power consumption of such machine[s].

### BACKGROUND OF THE INVENTION

Water and wastewater treatment systems typically employ numerous machines in the treatment and conveyance of water and wastewater. These machines include pumps, blowers and other electric, motor driven devices employed in numerous locations throughout a utility's system to convey and treat water and wastewater.

Pump stations generally employ a wetwell having multiple pumps operable to discharge a flow rate of water/wastewater at a desired pressure or head. Operation of the pumps at the pump stations are a significant source of the utility costs associated with operating a water and wastewater treatment facility or system. Heretofore, pump stations have used various control schemes for operating the pumps based on predetermined high and low water levels in wetwell operating the pumps based on predetermined high and low water levels in wetwell and/or on the water pressure generated on the system by the wastewater to be treated.

It can be appreciate that these widely used control schemes for operating pump stations have significant drawbacks. With known pump control schemes based solely on consideration of the water levels in the wetwells or on the pressure demands placed on the system by the wastewater, the pumps can be called on to operate at any time of the day or night and for a variable period of time. As hereinafter described, the random operation of the pumps at a pump station can significantly increase the utility costs charged by the electrical utility for electrical power consumption.

Electrical power utilities generally bill customers for the total amount of electrical power consumed over a standard period of time at a base billing rate. However, most electrical utilities charge a higher billing rate that is dependent on the customer power consumption and the time of day at which the consumption occurs. In other words, electrical utilities charge a higher billing rate for power consumption that occurs during predefined peak hours and a lower billing rate for power consumption that occurs during pre-defined, non-peak hours. Electrical utilities justify charging higher billing rates during peak hours because usage of power during peak hours requires the electrical utilities to maintain extra power generating capacity. As such, the electrical utilities must recover the costs associated with maintaining the extra power generating capacity.

In addition to tracking the total power consumption consumed over an extended period of time, electrical utilities also track a peak rate of electrical usage. The rate of electrical usage is generally tracked by averaging the electrical power consumption over a short term period, e.g., a 15-minute period. The electrical utility then varies the billing rate in view of the recorded peak rate of electrical usage recorded over the extended time period. This is commonly referred to as the peak demand. Electrical utilities charge customers for peak demand over the month (or for over the whole year) no matter if the peak demand occurred during peak or off peak hours. The utility charges the customer for the peak demand to deter demand during peak usage hours. Even though the peak demand occurs for only a short time period or during off-peak hours, the utility will apply the increased billing rate to the total electrical power consumption over the entire month or year.

In view of the above described billing structure of a typical electrical utility, it can be appreciated that a storm occurrence can have a significant effect on the costs associated with operation of a pump station. A storm typically causes a short term increase in the inflow to a pump station, e.g., associated with ground water and flow, leaks in the pipe, etc. Depending upon their strength of the storm, the storm event can trigger operation of one or both pumps in a pump station during peak hours of power consumption. Yet, as discussed above, operation of one or both pumps for only a short term period of time can cause a substantial increase in electrical costs charged for electrical consumption over the entire month or year because of the recorded peak demand at the pump station.

Thus, there is a need for a control scheme for machine operation that employs consideration for peak and non-peak hour operation when deciding whether to call a controlled machine (such as pump of a pump station) into operation. The control scheme must also include consideration for the necessary operation of the machine for proper performance and maintenance of the system.

For example, in regard to a wastewater pumping station, saving electrical costs by inhibiting operation of pumps during peak hours must be balanced with the necessity for operating the pumps to avoid a potential risk of causing basements to flood with sewage.

Therefore, it is a primary object and feature of the present invention to provide a method and control system configured to control operation of a machine in a manner that minimizes the operating costs associated with the electrical power consumption of such machine.

It is a further object and feature of the present invention to provide a method and control system configured to control operation of a machine that employs consideration for peak and non-peak hour operation when deciding whether to call the controlled machine (such as pump of a pump station) into operation.

It is a still further object and feature of the present invention to provide a method and control system configured to control operation of a machine that is simple and inexpensive to implement and that operates in more efficient manner than prior systems.

In accordance with the present invention, a method of controlling operation of a pump station is provided. The pumping station includes a first pump for pumping water from a wetwell. The method includes the step of comparing a status of a predetermined variable of the water in the pumping station, such as the water level of the water in the wetwell, with a first predetermined standard, such as a first predetermined water level. Thereafter, operation of the first pump is inhibited during a predetermined peak consumption period in response to the status of the predetermined variable exceeding the first predetermined standard.

The predetermined peak consumption period is determined by an electrical utility. The step of inhibiting operation of the first pump includes the additional steps of determining a present time of day and comparing the present time of day with the predetermined peak consumption period. Operation of the first pump is inhibited if the present time of day falls within the predetermined peak consumption period.

The first pump is operated in response to the water level in the wetwell exceeding the first predetermined level and the present time of day falling outside the predetermined peak consumption period. In addition, the first pump is operated in response to the water level in the wetwell exceeding a second predetermined level. The water level in the wetwell is monitored during operation of the first pump and operation of the first pump is terminated if the water level in the wetwell drops below the first predetermined level. In addition, operation of the first pump is terminated if the water level fails to rise for a predetermined portion of a predetermined peak demand time period. Similarly, the power demanded by the first pump is monitored during operation. If the power demanded by the first pump exceeds a first threshold, operation of the first pump is terminated.

A second pump may be operated to pump water from the wetwell in response to the water level rising during operation of the first pump or in response to the power demanded by the first pump exceeding the first threshold. Operation of the second pump is terminated if the water level in the wetwell drops below the first predetermined level.

In accordance with a further aspect of the present invention, a method of controlling operation of a pump station is provided. The pumping station includes a first pump for pumping water from a wetwell. The method includes the steps of determining a status of a predetermined variable of the water in the pumping station and inhibiting operation of the first pump during a predetermined peak consumption period if the status of the predetermined variable falls between a first lower threshold and a second higher threshold. The first pump is operated during the predetermined peak consumption if the status of the predetermined variable exceeds the second higher threshold.

The step of inhibiting operation of the first pump includes the additional steps of determining a present time of day and comparing the present time of day with the predetermined peak consumption period. Operation of the first pump is inhibited if the present time of day falls within the predetermined peak consumption period.

It is contemplated for the predetermined variable to be the water level of the water in the wetwell and for the first pump to be operated in response to the water level in the wetwell exceeding the first lower threshold and to the present time of day falling outside the predetermined peak consumption period. The water level in the wetwell is monitored during operation of the first pump and operation of the first pump is terminated if the water level in the wetwell drops below the first lower threshold. In addition, operation of the first pump is terminated if the water level fails to rise for a predetermined portion of a predetermined peak demand time period. Similarly, the power demanded by the first pump is monitored during operation. If the power demanded by the first pump exceeds a power threshold, operation of the first pump is terminated.

A second pump may be operated to pump water from the wetwell in response to the water level rising during operation of the first pump or in response to the power demanded by the first pump exceeding the power threshold operation of the second pump is terminated if the water level in the wetwell drops below the first lower threshold.

In accordance with a still further aspect of the present invention, a control system is provided for controlling operation of a pump station having a wetwell receiving water therein. The control system includes lead and lag pumps positioned in the wetwell for pumping water from the wetwell. A sensor structure defines a first threshold level of a predetermined variable and a second threshold level for the predetermined variable. A controller is operatively connected to the lead and lag pumps and to the sensor structure. The controller performs the steps of determining a status of a predetermined variable and inhibiting operation of the lead pump during a predetermined peak consumption period if the status of the predetermined variable falls between the first threshold level and the second threshold level. Optionally, comprising a communication device connectable to the controller for inputting data thereto.

It is contemplated for the predetermined variable to be a water level in the wetwell and for the sensor structure includes a first sensor for defining the first threshold level of water in the wetwell and a second sensor defining the second threshold level of water in the wetwell. The controller performs the additional step of activating the lead pump during the predetermined peak consumption period if the water level exceeds the second threshold level. In addition, the lead pump is activated outside the peak consumption period if the water level exceeds the first threshold level. Operation of the lead pump is terminated if the water level fails to rise for a predetermined portion of a predetermined peak demand time period or if the power demanded by the lead pump exceeds a power threshold.

The lag pump is activated to pump water from the wetwell in response to the water level rising during operation of the lead pump or in response to the power demanded by the lead pump exceeding the power threshold. Operation of the lag pump is terminated if the water level in the wetwell drops below the first threshold level.

Other objects, features, and advantages of the invention will become apparent to those skilled in the art from the following detailed description and accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

The drawings furnished herewith illustrate a preferred methodology of the present invention in which the above advantages and features are clearly disclosed as well as others which will be readily understood from the following description of the illustrated embodiment.

In the drawings:

FIG. 1 schematically illustrates a control system for a pump station in accordance with the present invention.

FIG. 2 illustrates an example of recorded electrical power consumption in accordance with the present invention.

FIG. 3 illustrates a flow diagram representative of a method of controlling a machine in accordance with the present invention.

### DETAILED DESCRIPTION OF THE DRAWINGS

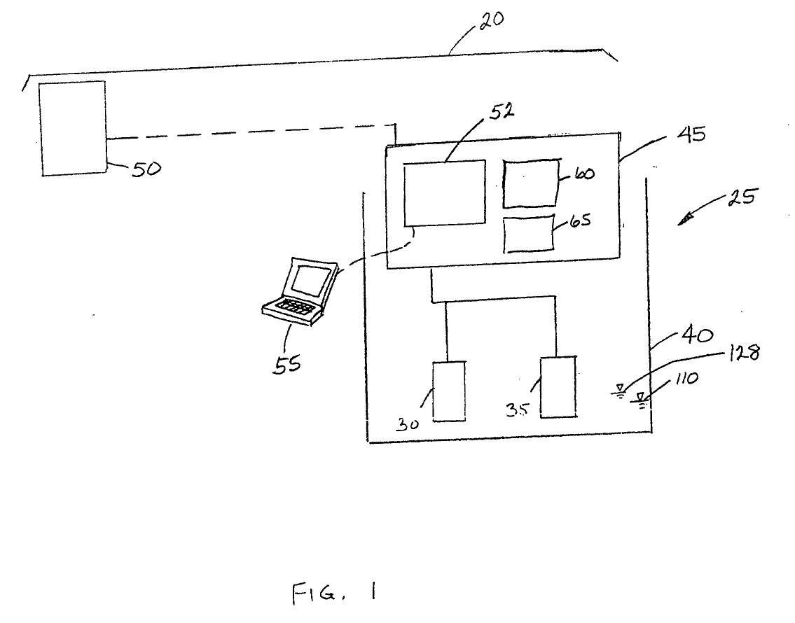

Referring to FIG. 1, a system for controlling operation of a pump station is generally designated by the reference numeral 20. As hereinafter described, it is intended for system 20 to include consideration for peak versus non-peak hour operation in view of machine performance. Although the illustrations and the following description refer to system 20 as a pump control system 20 for a pump station 25, the invention is not so limited. The method and system for controlling operation of a pump can be employed with operating numerous types of machines without deviating from the scope of the present invention.

FIG. 1 shows a control system 20 for controlling operation of a pair of pumps 30 and 35 disposed in the pump station 25 in accordance with the invention. The pair of pumps 30 and 35 generally include a lead pump 30 and a lag pump 35 called upon to operate in an alternating or combined sequence based on the rise of water level in a wetwell 40 defined by the pump station 25.

The control system 20 generally includes a local controller 45 in communication with the lead and lag pumps 30 and 35, respectively, disposed in the wetwell 40. A preferred local controller 45 is STATION BOSS™ Flow Control, but other types of controllers are possible without deviating from the scope of the present invention. The local controller 45 is also in communication via radio telemetry with a remote control station 50 such as a supervisory control data acquisition (SCADA) system, e.g. Energenecs Sensory Processor (ESP)™. The local controller 45 is generally configured to control on/off operation of the lead and lag pumps 30 and 35, respectively, with standard “control logic” for water levels in the wetwell 40, but with additional “energy logic” for energy management, as hereinafter described. The local controller 45 also generally includes emergency control logic to override the energy logic in view of a “high alarm” status of the wetwell 40 and initiate operation of one or both pumps 30 and 35.

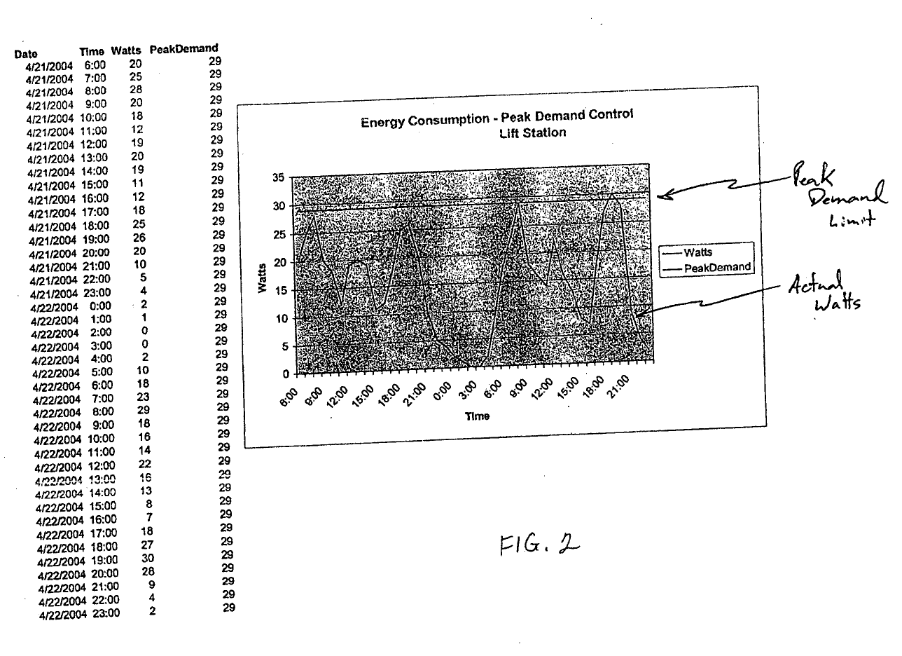

The local controller 45 preferably includes a touch pad 52 with display graphics to view recorded data and to provide control input. The local controller 45 is also configured to selectively connected for communication with a laptop 55 for downloading recorded data at the local controller associated with pump operation at defined timed period of day and associated electrical power consumption. The monitored data can include the flow pumped by each pump 30 and 35. As illustrated in FIG. 2, the recorded data can further include the associated electrical consumption (i.e., wattage) consumed by each pump 30 and 35 and the time of day to enable an operator to monitor and/or download the peak demand and the total power consumed at the pump station 25 on a predetermined time period basis (e.g., last 30 days). The laptop 55 can employ a software program such as by AFT Mercury from Applied Flow Technology™ to optimize pump operation costs with pump performance. In particular, the software can be utilized to analyze the downloaded electrical power consumption data (See, FIG. 2) and flow rate data as noted above to determine the optimum operating points of the pumps 30 and 35 in view of the electrical power consumed—thereby optimizing efficiency of the pump station 25.

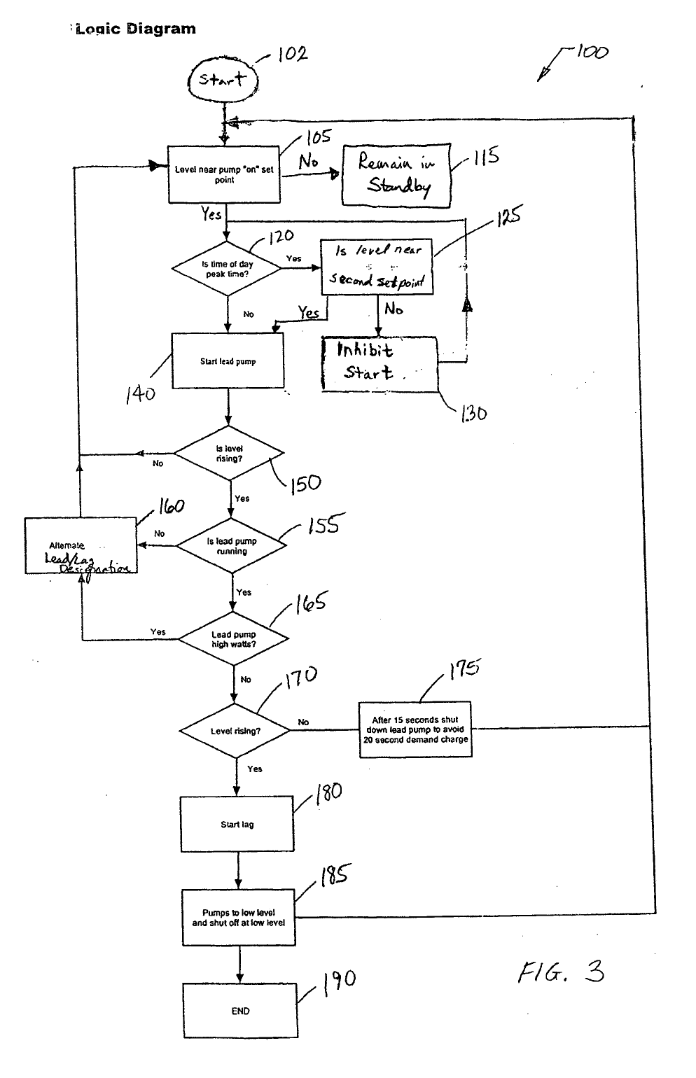

The local controller 45 also generally includes a processor 60 and a memory 65 for storing a software program configured to instruct the processor 60 to control on/off operation of the pumps 30 and 35 in accordance a method 100. FIG. 3 depicts a first embodiment of the method 100 of controlling operation of the lead and lag pumps 30 and 35, respectively, of the pump station 25 that incorporates the “energy logic” for energy management in accordance with the present invention.

The method 100 of the present invention is started by initializing the software program and the other components of pump control system 20, step 102. Step 105 includes determining a status of a predetermined variable of the water flowing into and through pump control system 20. The predetermined variable may take various forms including the pressure exerted by the water flowing into wetwell 40 or the water level in the wetwell 40. By way of example, the following description utilizes the water level in wetwell 40 as the predetermined variable. However, other variables are contemplated as being within the scope of the present invention. If the level of water in the wetwell 40 of the pump station 25 does not exceed a first predetermined level defined by a sensor 110, FIG. 1, the lead and lag pumps 30 and 35, respectively, of the pump station 25 are maintained in a standby mode (e.g., OFF position). Alternatively, if the water level is in the wetwell 40 is above the first predetermined level defined by sensor 110, FIG. 1, for turning on the lead pump 30, the present time of day is determined, step 120.

Referring to step 125, if the present time of day determined to be during a predetermined peak electrical power consumption period wherein local electrical utility bills at a higher rate for electrical power consumption (e.g., between 8 a.m. and 8 p.m.), the level of water in the wetwell 40 of the pump station 25 is compared to a second predetermined level defined by second sensor 128, FIG. 1. If the water level in wetwell 40 is not above the second predetermined level defined by second sensor 128, FIG. 1, operation of the lead pump 30 is inhibited for a predetermined time period, step 130. Thereafter, the methodology of the present invention contemplates returning to step of determining if the present time of day is during a predetermined peak electrical power consumption period, step 120. If the water level in the wetwell 40 is above the second predetermined level 128, FIG. 1, the lead pump 30 is started so as to pump water from the interior of the wetwell 40, step 140.

Alternatively, it is contemplated for the methodology of the present invention to incorporate several additional factors when comparing the present time of day with the predetermined peak electrical power consumption period into order to insure efficient operation of the pump control system 20. By way of example, hydraulic efficiencies, the number of pumps provided at pump station 25, and the instantaneous cost of the electrical power supplied to the pump station 25 may all be considered when determining when/if to inhibit operation of the lead pump 30.

After the lead pump 30 is started, step 140, the water level in the wetwell 40 of the pump station 25 is monitored, step 150. If the water level in the wetwell 40 does not rise after a predetermined time period, the methodology of the present invention contemplates returning to the step of determining the water level in the wetwell 40, step 105. If the water level in wetwell 40 continues to rise, it is determined whether the lead pump 30 is still operating or running, step 155. If the lead pump 30 is not running, lag pump 35 replaces lead pump 30, step 160, and the methodology of the present invention is restarted, step 100.

If it is determined that the lead pump 30 is running, the electrical demand of the lead pump 30 is measured and recorded, step 165. The measured electrical demand of the lead pump is compared to a predetermined peak demand threshold that is indicative of a malfunction of the lead pump 30. If the measured electrical demand of the lead pump is above a predetermined peak demand threshold, the method includes the steps of generating an alarm, shutting down the lead pump 30 and replacing lead pump 30 with lag pump 35, step 160, and the methodology of the present invention is restarted, step 100.

If the measured electrical power demand of the lead pump 30 is below the predetermined peak demand threshold, the water level in the wetwell 40 of the pump station 25 is monitored, step 170. If the water level in the wetwell 40 does not rise, the lead pump 30 is shut down after a predetermined time period that corresponds to a portion of a predetermined peak demand time period, e.g., 15 seconds, step 175. As heretofore described, the electrical utility sets a peak demand time period (e.g., 20 seconds) to measure the peak electrical power demand. By shutting down the lead pump 30 in a portion of such time period, the pumping station 20 can avoid recordation of a higher electrical power demand billing rate. If the water level in wetwell 40 continues to rise at step 170, the lag pump 35 is started, step 180. The combined operation of the lead and lag pumps 30 and 35, respectively, continues until the water level in the wetwell 40 drops below the first predetermined level defined by sensor 110, FIG. 1. Once the water level in the wetwell 40 drops below the first predetermined level defined by sensor 110, FIG. 1, the lead and lag pumps 30 and 35, respectively, are shut off. Thereafter, it is contemplated to return to step of determining the water level in the wetwell 40, step 105. Alternatively, the methodology of the present invention may be terminated, step 190.

As described, in contrast to known approaches for controlling the pump station 25, the methodology and control system of the present invention allows a user to optimize the power consumption of the pumping station by utilizing feedback from the pumps to identify the most efficient operating points for the pumping station 25. The storage capacity of the wetwell 40 and the overall sewage system (e.g., laterals, manholes, etc.) are used to surcharge the sewage system for short time periods so as to minimize electrical costs associated with pumping at the pump station 25 without sacrificing performance of the sewage system.

Various modes of carrying out the invention are contemplated as being within the scope of the following claims particularly pointing out and distinctly claiming the subject matter that is regarded as the invention.

1. A method of controlling operation of a pump station, the pumping station including a first pump for pumping water from a wetwell, comprising the steps of:
comparing a status of a predetermined variable of the water in the pumping station with a first predetermined standard; and
inhibiting operation of the first pump during a predetermined peak consumption period in response to the status of the predetermined variable exceeding the first predetermined standard.

2. The method of claim 1 wherein the predetermined peak consumption period is determined by an electrical utility.

3. The method of claim 1 wherein the step of inhibiting operation of the first pump includes the additional steps of:
determining a present time of day;
comparing the present time of day with the predetermined peak consumption period; and
inhibiting operation of the first pump if the present time of day falls within the predetermined peak consumption period.

4. The method of claim 3 wherein the predetermined variable is a water level in the wetwell and the first predetermined standard is a first predetermined level of water in the wetwell.

5. The method of claim 4 further comprising the additional step of operating the first pump in response to:
the water level in the wetwell exceeding the first predetermined level; and
the present time of day falling outside the predetermined peak consumption period.

6. The method of claim 5 comprising the additional steps of:
monitoring the water level in the wetwell during operation of the first pump; and
terminating the operation of the first pump if the water level in the wetwell drops below the first predetermined level.

7. The method of claim 6 comprising the additional step of terminating the operation of the first pump if the water level fails to rise for a predetermined portion of a predetermined peak demand time period

8. The method of claim 6 comprising the additional step of operating a second pump to pump water from the wetwell in response to the water level rising during operation of the first pump.

9. The method of claim 8 comprising the additional step of terminating the operation of the second pump if the water level in the wetwell drops below the first predetermined level.

10. The method of claim 6 comprising the additional steps of:
monitoring power demanded by the first pump during operation; and
terminating the operation of the first pump if the power demanded by the first pump exceeds a first threshold.

11. The method of claim 10 comprising the additional step of operating a second pump to pump water from the wetwell in response to the power demanded by the first pump exceeding the first threshold.

12. The method of claim 1 comprising the additional step of allowing operation of the first pump in response to the status of the predetermined variable exceeding a second predetermined standard.

13. A method of controlling operation of a pump station, the pumping station including a first pump for pumping water from a wetwell, comprising the steps of:
determining a status for a predetermined variable of the water in the pumping station;
inhibiting operation of the first pump during a predetermined peak consumption period if the status of the predetermined variable falls between a first lower threshold and a second higher threshold; and
operating the first pump during the predetermined peak consumption if the status of the predetermined variable exceeds the second higher threshold.

14. The method of claim 13 wherein the step of inhibiting operation of the first pump includes the additional steps of:
determining a present time of day;
comparing the present time of day with the predetermined peak consumption period; and
inhibiting operation of the first pump if the present time of day falls within the predetermined peak consumption period.

15. The method of claim 14 wherein the predetermined variable is a water level of the water in the wetwell and wherein the method comprises the additional step of operating the first pump in response to:
the water level in the wetwell exceeding the first lower threshold and
the present time of day falling outside the predetermined peak consumption period.

16. The method of claim 15 comprising the additional steps of:
monitoring the water level in the wetwell during operation of the first pump; and
terminating the operation of the first pump if the water level in the wetwell drops below the first lower threshold.

17. The method of claim 16 comprising the additional step of terminating the operation of the first pump if the water level fails to rise for a predetermined portion of a predetermined peak demand time period.

18. The method of claim 16 comprising the additional step of operating a second pump to pump water from the wetwell in response to the water level rising during operation of the first pump.

19. The method of claim 18 comprising the additional steps of terminating the operation of the second pump if the water level in the wetwell drops below the first lower threshold.

20. The method of claim 16 comprising the additional steps of:
monitoring power demanded by the first pump during operation; and
terminating the operation of the first pump if the power demanded by the first pump exceeds a power threshold.

21. The method of claim 20 comprising the additional step of operating a second pump to pump water from the wetwell in response to the power demanded by the first pump exceeding the power threshold.

22. A control system for controlling operation of a pump station having a wetwell for receiving water therein, comprising:
a lead pump positioned in the wetwell for pumping water from the wetwell;
a lag pump positioned in the wetwell;
a sensor structure positioned in the pump station, the sensor structure defining first and second threshold levels for a predetermined variable for the water; and
a controller operatively connected to the lead and lag pumps and to the sensor structure, the controller performing the steps of:
determining a status for the predetermined variable;
inhibiting operation of the lead pump during a predetermined peak consumption period if the status of the predetermined variable falls between the first threshold level and the second threshold level.

23. The control system of claim 23 wherein:
the predetermined variable is a water level in the wetwell; and
the sensor structure includes a first sensor for defining the first threshold level of water in the wetwell and a second sensor defining the second threshold level of water in the wetwell;

24. The control system of claim 23 wherein the controller performs the additional step of activating the lead pump during the predetermined peak consumption period if the water level exceeds the second threshold level.

25. The control system of claim 23 wherein the controller performs the additional step of activating operation of the lead pump outside the peak consumption period if the water level exceeds the first threshold level.

26. The control system of claim 25 wherein the controller performs the additional step of terminating operation of the lead pump if the water level fails to rise for a predetermined portion of a predetermined peak demand time period.

27. The control system of claim 25 wherein the controller performs the additional step of activating operation of the lag pump water from the wetwell in response to the water level rising during operation of the lead pump.

28. The control system of claim 27 wherein the controller performs the additional step of terminating operation of the lag pump if the water level in the wetwell drops below the first threshold level.

29. The control system of claim 27 wherein the controller performs the additional steps of:
monitoring power demanded by the lead pump during operation; and
terminating the operation of the lead pump if the power demanded by the lead pump exceeds a power threshold.

30. The control system of claim 29 wherein the controller performs the additional step of activating operation of the lag pump to pump water from the wetwell in response to the power demanded by the lead pump exceeding the power threshold.

31. The control system of claim 22 further comprising a communication device connectable to the controller for inputting data thereto.
